(19) United States
(12) Patent Application Publication
(10) Pub. No.: US 2019/0333273 A1
(43) Pub. Date: Oct. 31, 2019

(54) AUGMENTED REALITY SYSTEMS AND METHODS FOR ASSISTING GAMING ENVIRONMENT OPERATIONS

(71) Applicant: IGT, Las Vegas, NV (US)

(72) Inventors: Dwayne Nelson, Las Vegas, NV (US); Kevin Higgins, Reno, NV (US)

(21) Appl. No.: 15/962,313

(22) Filed: Apr. 25, 2018

(51) Int. Cl. G06T 19/00; G07F 17/32; G06K 9/00; G10L 15/00; G10L 15/18; G06F 17/28

(52) U.S. Cl. CPC G06T 19/006; G07F 17/3239; G07F 17/3241; G06K 9/00335; G06F 17/289; G07F 17/3206; G10L 15/005; G10L 15/1822; G06K 9/00671

(57) ABSTRACT

A computer-implemented method includes generating a live video signal of a scene associated with a field of view of a casino operator, wherein the scene comprises a first player in a casino environment. The method further includes determining, based on the live video signal, a first value for the first player in real time. The method further includes displaying an indication to the casino operator of the first value in real time, so that the indication is associated with the first player within the scene.

### FIELD

Embodiments described herein relate to augmented reality (AR) systems and methods, and in particular to AR systems and methods for assisting gaming environment operations.

### BACKGROUND

Gaming environment operations, such as casino operations for example, include many different tasks and responsibilities for different operations personnel. For example, an operations worker on a casino floor may be responsible for managing electronic game machines (EGMs) such as slot machines, video lottery terminals, or video poker machines, managing table games such as blackjack or roulette, and/or managing other aspects of the casino floor, such as drink service or hospitality services. An operations worker may also be required to personally interact with casino patrons and/or casino staff, which may require the employee to identify and remember personal details regarding a large number of people and situations in a dynamic, service-oriented environment.

### SUMMARY

According to some embodiments, a computer-implemented method includes generating a live video signal of a scene associated with a field of view of a casino operator, wherein the scene includes a first player in a casino environment. The method further includes determining, based on the live video signal, a first value for the first player in real time. The method further includes displaying an indication to the casino operator of the first value in real time, so that the indication is associated with the first player within the scene.

According to further embodiments, a system includes a memory and a processor coupled to the memory, the processor operable to perform a method. The method includes generating a live video signal of a scene associated with a field of view of a casino operator, wherein the scene includes a first player in a casino environment. The method further includes determining, based on the live video signal, a first value for the first player in real time. The method further includes displaying an indication to the casino operator of the first value in real time, so that the indication is associated with the first player within the scene.

According to further embodiments, a non-transitory computer-readable medium includes machine-readable instructions operable to cause a processor to perform a method. The method includes generating a live video signal of a scene associated with a field of view of a casino operator, wherein the scene includes a first player in a casino environment. The method further includes determining, based on the live video signal, a first value for the first player in real time. The method further includes displaying an indication to the casino operator of the first value in real time, so that the indication is associated with the first player within the scene.

### BRIEF DESCRIPTION OF THE DRAWINGS

FIG. 1 is a schematic block diagram illustrating a network configuration for a plurality of gaming devices according to some embodiments.

FIGS. 2A to 2D illustrate augmented reality (AR) viewers according to various embodiments.

FIG. 3A is a map of a gaming area, such as a casino floor.

FIG. 3B is a 3D wireframe model of the gaming area of FIG. 3A.

FIG. 4 is a view illustrating a casino operations worker using an AR viewer to identify a plurality of players playing a table game according to an embodiment;

FIG. 5 is a view illustrating a casino operations worker using an AR viewer to identify player information and preferences for the plurality of players according to an embodiment;

FIG. 6 is a view illustrating a casino operations worker using an AR viewer to communicate with a player speaking a different language according to an embodiment;

FIG. 7 is a view illustrating a casino operations worker using an AR viewer to estimate a level of intoxication for a player according to an embodiment;

FIG. 8 is a flowchart diagram of a method of using an AR viewer to determine information about a player according to an embodiment; and

FIG. 9 is a block diagram that illustrates various components of an AR viewer device according to some embodiments

### DETAILED DESCRIPTION

Embodiments described herein relate to augmented reality (AR) systems and methods, and in particular to AR systems and methods for assisting gaming environment operations. According to some embodiments, a computer-implemented method includes generating a live video signal of a scene associated with a field of view of a casino operator, wherein the scene comprises a first player in a casino environment. The method further includes determining, based on the live video signal, a first value for the first player in real time. The method further includes displaying an indication to the casino operator of the first value in real time, so that the indication is associated with the first player within the scene.

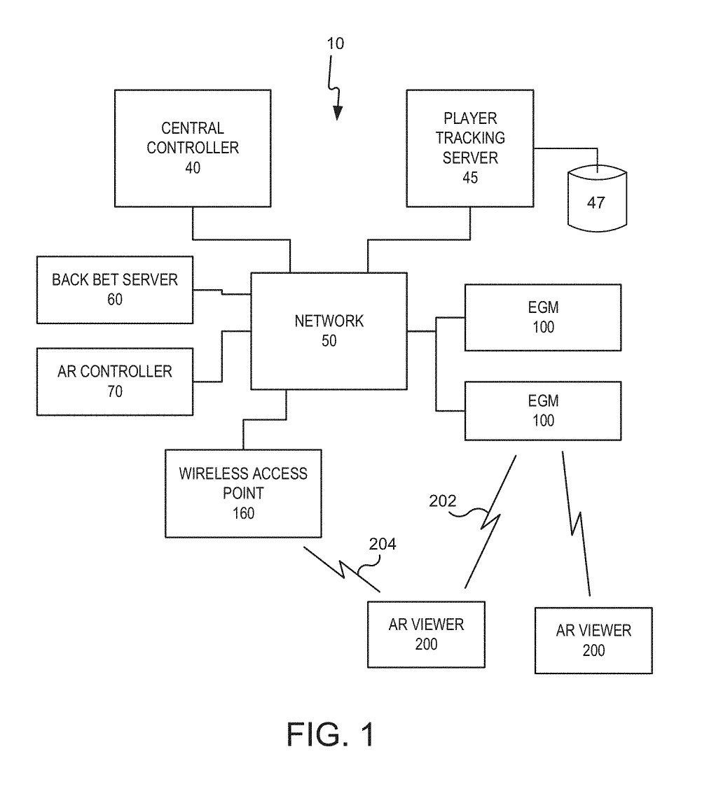

Before discussing aspects of the embodiments disclosed herein, reference is made to FIG. 1, which illustrates a networked gaming system 10 that includes a plurality of electronic gaming machines (EGMs) 100 and AR viewers 200. The gaming system 10 may be located, for example, on the premises of a gaming establishment, such as a casino. The EGMs 100, which are typically situated on a casino floor, may be in communication with each other and/or at least one central controller 40 through a data network or remote communication link 50. The data communication network 50 may be a private data communication network that is operated, for example, by the gaming facility that operates the EGM 100. Communications over the data communication network 50 may be encrypted for security. The central controller 40 may be any suitable server or computing device which includes at least one processor and at least one memory or storage device. Each EGM 100 may include a processor that transmits and receives events, messages, commands or any other suitable data or signal between the EGM 100 and the central controller 40. The EGM processor is operable to execute such communicated events, messages or commands in conjunction with the operation of the EGM. Moreover, the processor of the central controller 40 is configured to transmit and receive events, messages, commands or any other suitable data or signal between the central controller 40 and each of the individual EGMs 100. In some embodiments, one or more of the functions of the central controller 40 may be performed by one or more EGM processors. Moreover, in some embodiments, one or more of the functions of one or more EGM processors as disclosed herein may be performed by the central controller 40.

A wireless access point 160 provides wireless access to the data communication network 50. The wireless access point 160 may be connected to the data communication network 50 as illustrated in FIG. 1, or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47 and uploaded to the player tracking server 45 as needed.

As further illustrated in FIG. 1, an augmented reality (AR) viewer 200 is provided. The AR viewer 200 communicates with one or more elements of the system 10 to render two-dimensional (2D) and/or three-dimensional (3D) content to a user, e.g., a casino operations worker, in a virtual space, while at the same time allowing the casino operations worker to see objects in the real space around the user, e.g., on the casino floor. That is, the AR viewer 200 combines a virtual image with real images perceived by the user, including images of real objects. In this manner, the AR viewer 200 “mixes” real and virtual reality into a single viewing experience for the user. In some embodiments, the AR viewer 200 may be further configured to enable the user to interact with both the real and virtual objects displayed to the player by the AR viewer 200.

The AR viewer 200 communicates with one or more elements of the system 10 to coordinate the rendering of augmented reality (AR), which may also be referred to as mixed reality, images, and in some embodiments AR 3D images, to the user. For example, in some embodiments, the AR viewer 200 may communicate directly with an EGM 100 over a wireless interface 202, which may be a Wi-Fi link, a Bluetooth link, an NFC link, etc. In other embodiments, the AR viewer 200 may communicate with the data communication network 50 (and devices connected thereto, including EGMs) over a wireless interface 204 with the wireless access point 160. The wireless interface 204 may include a Wi-Fi link, a Bluetooth link, an NFC link, etc. In still further embodiments, the AR viewer 200 may communicate simultaneously with both the EGM 100 over the wireless interface 202 and the wireless access point 160 over the wireless interface 204. In these embodiments, the wireless interface 202 and the wireless interface 204 may use different communication protocols and/or different communication resources, such as different frequencies, time slots, spreading codes, etc. For example, in some embodiments, the wireless interface 202 may be a Bluetooth link, while the wireless interface 204 may be a Wi-Fi link.

The wireless interfaces 202, 204 allow the AR viewer 200 to coordinate the generation and rendering of AR images to the user via the AR viewer 200.

In some embodiments, the gaming system 10 includes an AR controller, or AR controller 70. The AR controller 70 may be a computing system that communicates through the data communication network 50 with the EGMs 100 and the AR viewers 200 to coordinate the generation and rendering of virtual images to one or more users using the AR viewers 200. The AR controller 70 may be implemented within or separately from the central controller 40.

In some embodiments, the AR controller 70 may coordinate the generation and display of the virtual images of the same virtual object to more than one user by more than one AR viewer 200. As described in more detail below, this may enable multiple users to interact with the same virtual object together in real time. This feature can be used to provide a shared experience to multiple users at the same time.

The AR controller 70 may store a three-dimensional wireframe map of a gaming area, such as a casino floor, and may provide the three-dimensional wireframe map to the AR viewers 200. The wireframe map may store various information about EGMs and other games or locations in the gaming area, such as the identity, type and location of various types of EGMs or other games. The three-dimensional wireframe map may enable an AR viewer 200 to more quickly and accurately determine its position and/or orientation within the gaming area, and also may enable the AR viewer 200 to assist the user in navigating the gaming area while using the AR viewer 200. The generation of three-dimensional wireframe maps is described in more detail below.

In some embodiments, at least some processing of virtual images and/or objects that are rendered by the AR viewers 200 may be performed by the AR controller 70, thereby offloading at least some processing requirements from the AR viewers 200. The AR viewer may also be able to communicate with other aspects of the gaming system 10, such as the player tracking server 45, a back bet server 60, or other device through the network 50.

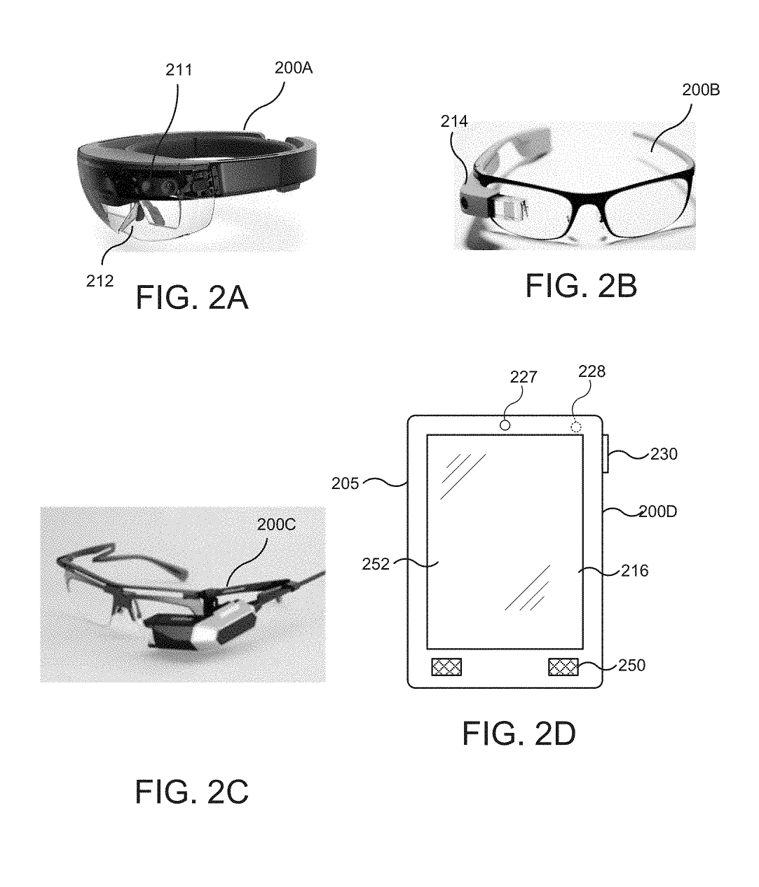

Referring to FIGS. 2A to 2D, the AR viewer 200 may be implemented in a number of different ways. For example, referring to FIG. 2A. in some embodiments, an AR viewer 200A may be implemented as a 3D headset including a pair of semitransparent lenses 212 on which images of virtual objects may be displayed. Different stereoscopic images may be displayed on the lenses 212 to create an appearance of depth, while the semitransparent nature of the lenses 212 allow the user to see both the real world as well as the 3D image rendered on the lenses 212. The AR viewer 200A may be implemented, for example, using a Hololens™ from Microsoft Corporation. The Microsoft Hololens includes a plurality of cameras and other sensors 211 that the device uses to build a 3D model of the space around the user. The device 200A can generate a 3D image to display to the user that takes into account the real-world objects around the user and allows the user to interact with the 3D object.

The device 200A may further include other sensors, such as a gyroscopic sensor, a GPS sensor, one or more accelerometers, and/or other sensors that allow the device 200A to determine its position and orientation in space. In further embodiments, the device 200A may include one or more cameras that allow the device 200A to determine its position and/or orientation in space using visual simultaneous localization and mapping (VSLAM). The device 200A may further include one or more microphones and/or speakers that allow the user to interact audially with the device.

Referring to FIG. 2B, an AR viewer 200B may be implemented as a pair of glasses 200B including a transparent prismatic display 214 that displays an image to a single eye of the user. An example of such a device is the Google Glass device. Such a device may be capable of displaying images to the user while allowing the user to see the world around the user, and as such can be used as an AR viewer.

In other embodiments, referring to FIG. 2C, the AR viewer may be implemented using a virtual retinal display device 200C. In contrast to devices that display an image within the field of view of the user, a virtual retinal display raster scans an image directly onto the retina of the user. Like the device 200B, the virtual retinal display device 200C combines the displayed image with surrounding light to allow the user to see both the real world and the displayed image. However, also like the device 200B, the virtual retinal display device 200C may be incapable of displaying 3D images to the user.

In still further embodiments, an AR viewer 200D may be implemented using a mobile wireless device, such as a mobile telephone, a tablet computing device, a personal digital assistant, or the like. The device 200D may be a handheld device including a housing 205 on which a touchscreen display device 216 including a digitizer 252 is provided. An input button 230 may be provided on the housing and may act as a power or control button. A rear facing camera 227 may be provided in a front face of the housing 205. The device 200D may further include a front facing camera 228 on a rear face of the housing 205. The device 200D may include one or more speakers 250 and a microphone 229. The device 200D may provide an AR display by capturing a video signal using the front facing camera 228 and displaying the video signal on the display device 216, and also displaying a rendered image of a virtual object over the captured video signal. In this manner, the user may see both a mixed image of both a real object in front of the device 200D as well as a virtual object superimposed over the real object to provide an AR viewing experience.

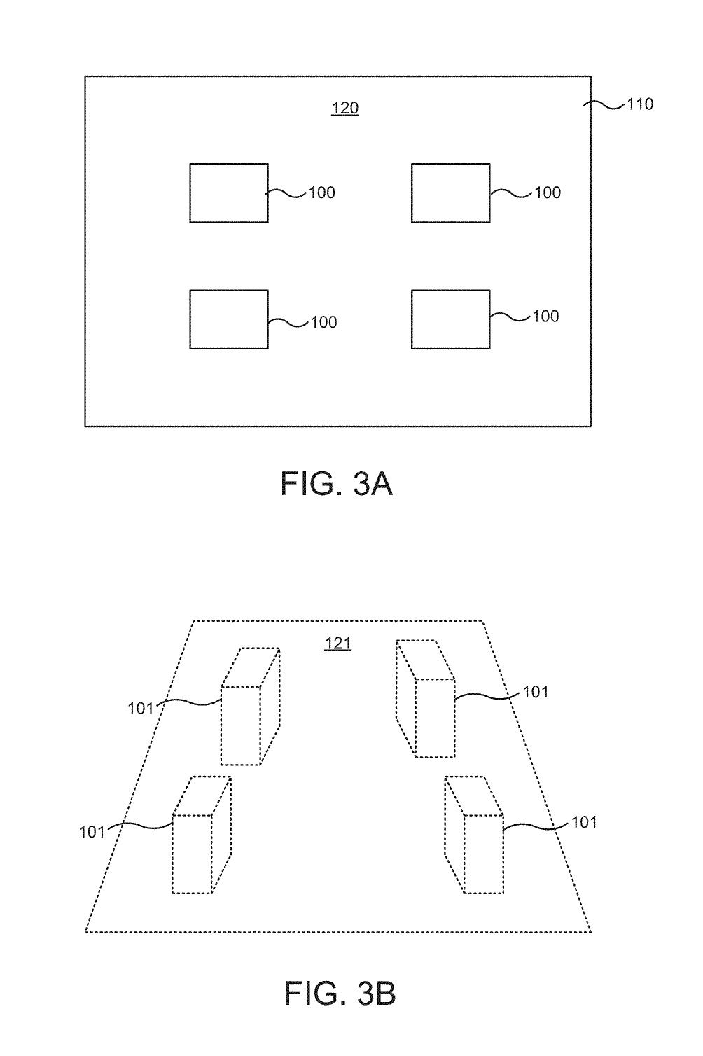

Referring now to FIG. 3A, an example map 110 of a gaming area 120 is illustrated in plan view. The gaming area 120 may, for example, be a casino floor. The map 110 shows the location of a plurality of EGMs 100 within the gaming area 120. As will be appreciated, the locations of the EGMs 100 and other games and objects (not shown) within a gaming area 120 are generally fixed, although a casino operator may relocate EGMs from time to time, such as when new EGMs are introduced, to create new traffic flow patterns within the gaming area 120, to feature or highlight certain games, etc. As noted above, in order to assist the operation of the AR viewers 200, the AR controller 70 may store a three-dimensional wireframe map of the gaming area 120, and may provide the three-dimensional wireframe map to the AR viewers 200.

An example of a wireframe map 121 is shown in FIG. 3B. The wireframe map is a three-dimensional model of the gaming area 120. As shown in FIG. 3B, the wireframe map 121 includes wireframe models 101 corresponding to the EGMs 100 that are physically in the gaming area 120. The wireframe models 101 may be pregenerated to correspond to various EGM form factors, such as single display EGMs, mechanical slot EGMs, dual display EGMs, etc. The pregenerated models may then be placed into the wireframe map, for example, by a designer or other personnel. The wireframe map 121 may be updated whenever the physical location of EGMs in the gaming area 120 is changed.

In some embodiments, the wireframe map 121 may be generated automatically using an AR viewer 200, such as a 3D headset, that is configured to perform a three-dimensional depth scan of its surroundings and generate a three-dimensional model based on the scan results. Thus, for example, an operator using an AR viewer 200A (FIG. 2A) may perform a walkthrough of the gaming area 120 while the AR viewer 200A builds the 3D map of the gaming area.

The three-dimensional wireframe map 121 may enable an AR viewer 200 to more quickly and accurately determine its position and/or orientation within the gaming area. For example, an AR viewer 200 may determine its location within the gaming area 120 using one or more position/orientation sensors. The AR viewer 200 then builds a three-dimensional map of its surroundings using depth scanning, and compares its sensed location relative to objects within the generated three-dimensional map with an expected location based on the location of corresponding objects within the wireframe map 121. The AR viewer 200 may calibrate or refine its position/orientation determination by comparing the sensed position of objects with the expected position of objects based on the wireframe map 121. Moreover, because the AR viewer 200 has access to the wireframe map 121 of the entire gaming area 120, the AR viewer 200 can be aware of objects or destinations within the gaming area 120 that it has not itself scanned. Processing requirements on the AR viewer 200 may also be reduced because the wireframe map 121 is already available to the AR viewer 200.

In some embodiments, the wireframe map 121 may store various information about EGMs or other games and locations in the gaming area, such as the identity, type, orientation and location of various types of EGMs, the locations of exits, bathrooms, courtesy desks, cashiers, ATMs, ticket redemption machines, etc. Such information may be used by an AR viewer 200 to help the user navigate the gaming area. For example, if a user desires to find a destination within the gaming area, the user may ask the AR viewer 200 for directions using a built-in microphone and voice recognition function in the AR viewer 200 or use other hand gestures or eye/gaze controls tracked by the AR viewer 200 (instead of or in addition to voice control). The AR viewer 200 may process the request to identify the destination, and then may display a virtual object, such as a virtual path on the ground, virtual arrow, virtual sign, etc., to help the user to find the destination. In some embodiments, for example, the AR viewer 200 may display a halo or glow around the destination to highlight it for the user, or have virtual 3D sounds coming from it so users could more easily find the desired location.

According to some embodiments, a user of an AR viewer 200 may use the AR viewer to obtain information about players and/or EGMs on a casino gaming floor. The information may be displayed to the user on the AR viewer 200 in a number of different ways such as by displaying images on the AR viewer 200 that appear to be three dimensional or two-dimensional elements of the scene as viewed through the AR viewer 200. In general, the type and/or amount of data that is displayed to the user may depend on what type of user is using the AR viewer 200 and, correspondingly, what level of permissions or access the user has. For example, an AR viewer 200 may be operated in one of a number of modes, such as a player mode, an observer mode or an operator mode. In a player mode, the AR viewer 200 may be used to display information about particular EGMs on a casino floor. The information may be generic information about an EGM or may be customized information about the EGM based on the identity or preferences of the user of the AR viewer 200. In an observer mode, the AR viewer 200 may be used to display information about particular EGMs on a casino floor or information about players of EGMs on the casino floor. In an operator mode, which is described in greater detail below, the AR viewer 200 may be used to display information about particular EGMs or other games on a casino floor or information about players of EGMs or other games on the casino floor, but the information may be different or more extensive than the information displayed to an observer or player.

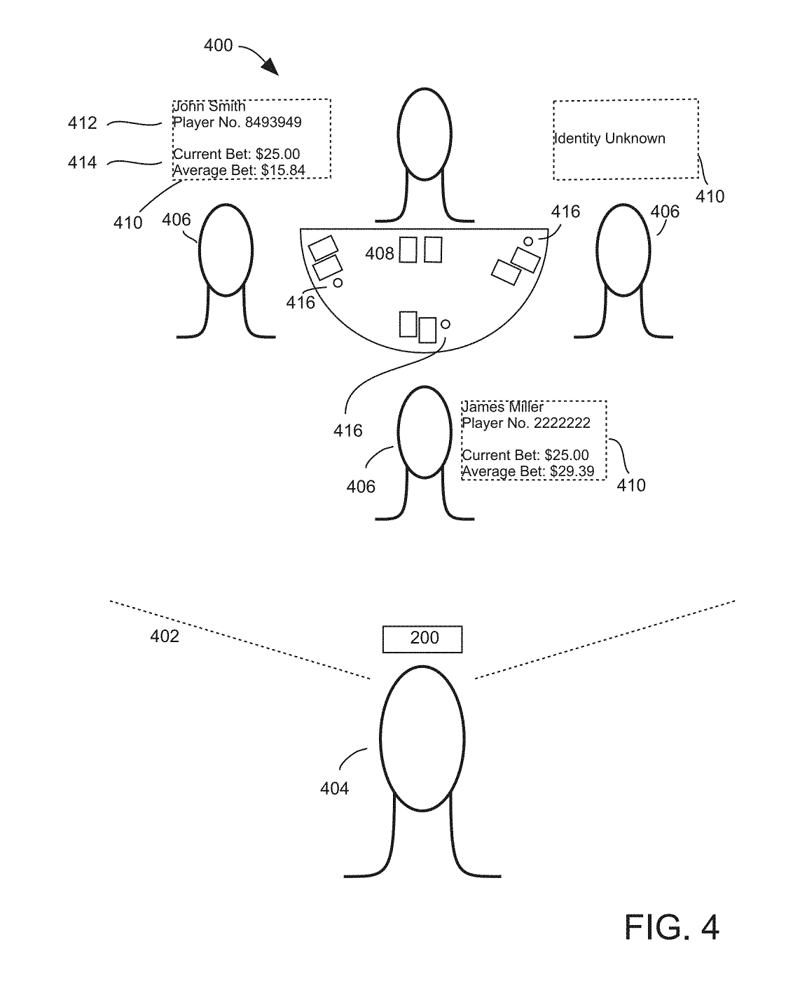

In this regard, FIG. 4 is a view illustrating a casino operations worker using an AR viewer in operator mode to identify a plurality of players playing a table game according to an embodiment. The AR viewer 200 generates a live video signal of a scene 400 associated with a field of view 402 of a user 404, e.g., a casino operations worker. In this example, the scene 400 includes a plurality of players playing a table game 408 in a casino environment. The AR viewer 200 determines, based on the live video signal or based on a manual or other input provided by the user 404 or another individual, an identity and one or more values associated with each of the players 406 and displays indications 410 to the user 404 in real time so that each indication 410 is associated with the respective player 406 within the scene 400. The identity of the player 406 may be determined in a number of ways, including facial recognition, correlating a location of the player 406 at the table with a player card number associated with the table location, or other method. If the AR viewer 400 is unable to determine the identity of the player 406 directly, the identity of the player 406 may be provided to the AR viewer 400 indirectly, such as by receiving manual or other input from the user 404 or another individual.

The indications 410 can include, for each player, an identity indication 412 that identifies the player 406 and one or more value indications 414, which may include an average wager value, a win/loss value, a player status, a player's birthday, whether the player is a new player, and/or any number of other pieces of information associated with the user 404. If the AR viewer 200 is unable to identify the player 406, on the other hand, the indication 410 may indicate that the identity of the player 406 is unknown. The type of indication 410 may be customized to include text, graphics, animation, photos, audio cues, etc., or combinations thereof. More important information can be presented to the user 404 more prominently and/or automatically, while other information may be less prominent, or may be selectively accessed through a user interface associated with the AR viewer 200, as desired.

In this example, the AR viewer 200 may determine one or more wagers 416 placed by the player(s) 406 in real time. Based at least in part on the wager(s) 416, the AR viewer 200 determines an average wager value for the first player. The determined average wager value can then be presented to the user 404 as part of the value indication 414 associated with the respective player 406 within the scene 400.

In this example as well, the AR viewer 200 may determine one or more game results of the game 408 for the player(s) 406 in real time. Based at least in part on the wager(s) 416, the AR viewer 200 determines one or more win/loss values for the player(s) 406. The determined win/loss value(s) can then be presented to the user 404 as part of the value indication 414 associated with the respective player 406 within the scene 400. The AR viewer 200 may determine the game result directly, e.g., by processing input from the live video signal to determine the game result, or indirectly, e.g., by receiving a manual or other input from the user 404 or another individual observing the game result. Additional indications may be determined based on aspects of the game, such as a table game or an EGM, and displayed in association with the game as well.

Examples of other types of indications 410 that may be determined and presented in real time via the AR viewer 200 are discussed in greater detail below.

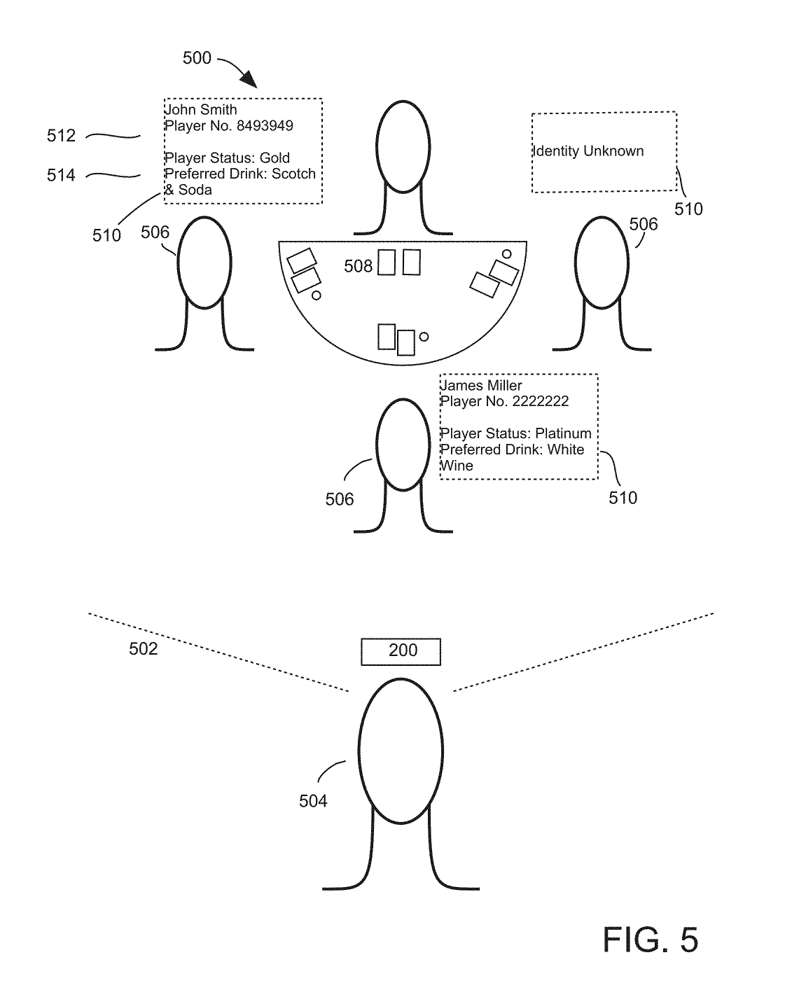

In this regard, FIG. 5 is a view illustrating a user 504, e.g., a casino operations worker, using an AR viewer 200 to identify player information and preferences for a plurality of players 506 of a game 508 within a scene 500 associated with a field of view 502 of a user 504, according to an embodiment. In this example, the AR viewer 200 may be able to determine other information associated with a player 506, such as a player status, loyalty account status, recent gaming activity, including types of games played and recent significant wins or losses. Other information may include a hold percentage or player return for the player 406 and/or game 408, a current configuration of the game 408 (e.g., game selection, denomination, etc.), or other gaming activity information. The AR viewer 200 may be able to determine other information regarding non-gaming activity, such as recent non-gaming activity (e.g., shows, dining, shopping, spa, etc.), travel information (e.g., hotel and room number, check-in/check-out dates, flight information), the relationships between the player and other players, a drink preference, or other information for one or more players 506, based on the respective determined identities of the player(s) 506. The AR viewer 200 displays indications 510 to the user 504 in real time so that each indication 510 is associated with the respective player 506 within the scene 500. The indications 510 can include, for each player 506, an identity indication 512 that identifies the player 506 and one or more value indications 514, which may include an indication of the drink preference(s) and/or player status(es) for the player(s) 506. This would allow a user 404 to bring the player 406 his or her preferred drink (or order the drink on the player's 406 behalf) without the need for the player 406 ordering it. Other information that may be determined by the AR viewer 200 and included in the value indication(s) 514 may include: a language preference, including an indication of whether the player 506 and the user 504 speak a common language, and/or a cultural preference, such as a preferred greeting or other etiquette behavior, or a cultural superstition, e.g., lucky number, that may be associated with the game 508 being played by the player 506.

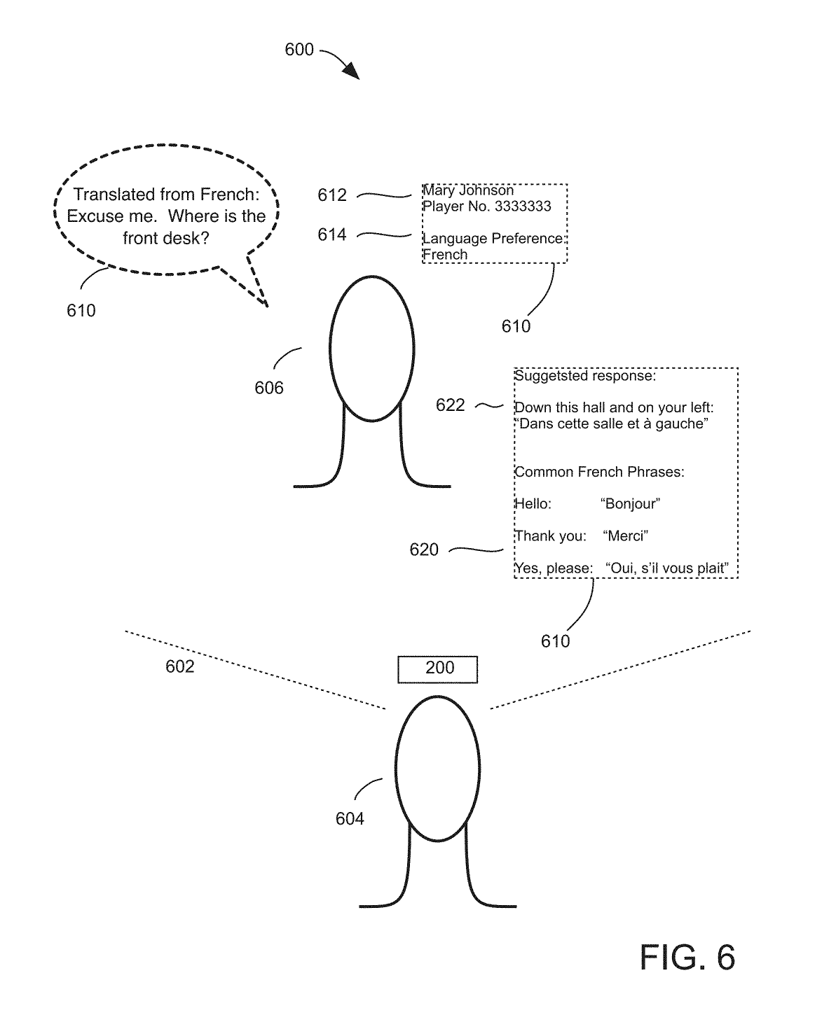

FIG. 6 is a view illustrating a user 604 using an AR viewer 200 to communicate with a player 606 speaking a different language, within a scene 600 associated with a field of view 602 of the user 604, according to an embodiment. In this example, the AR viewer determines, based on the determined identity of the player 606, a language preference for the first player in real time. The AR viewer 200 displays one or more indications 610 to the user 604 in real time so that each indication 610 is associated with the player 606 within the scene 600. The indications 610 can include an identity indication 612 that identifies the player 606 and one or more value indications 614, which may include an indication of the language preference for the player(s) 606. In this embodiment, the value indications 614 may also include indications of one or more common phrases 620 in the player's 606 preferred language, in order to help the user 604 communicate with the player 606 in his or her preferred language. The AR viewer 200 may also be able to translate, in real time, words or phrases being spoken by the player 606 in his or her preferred language and display, a translation indication of the words or phrases translated into a preferred language of the user 604. The AR viewer 200 may also determine a responsive phrase 622 based on the translated words or phrases, and display, as part of the value indication 614 or as part of a different indication, an indication that allows the user to speak the responsive phrase in the player's 606 preferred language. The indication may include the actual phrase in the player's 606 preferred language, and/or a phonetic representation of the phrase in the player's 606 preferred language.

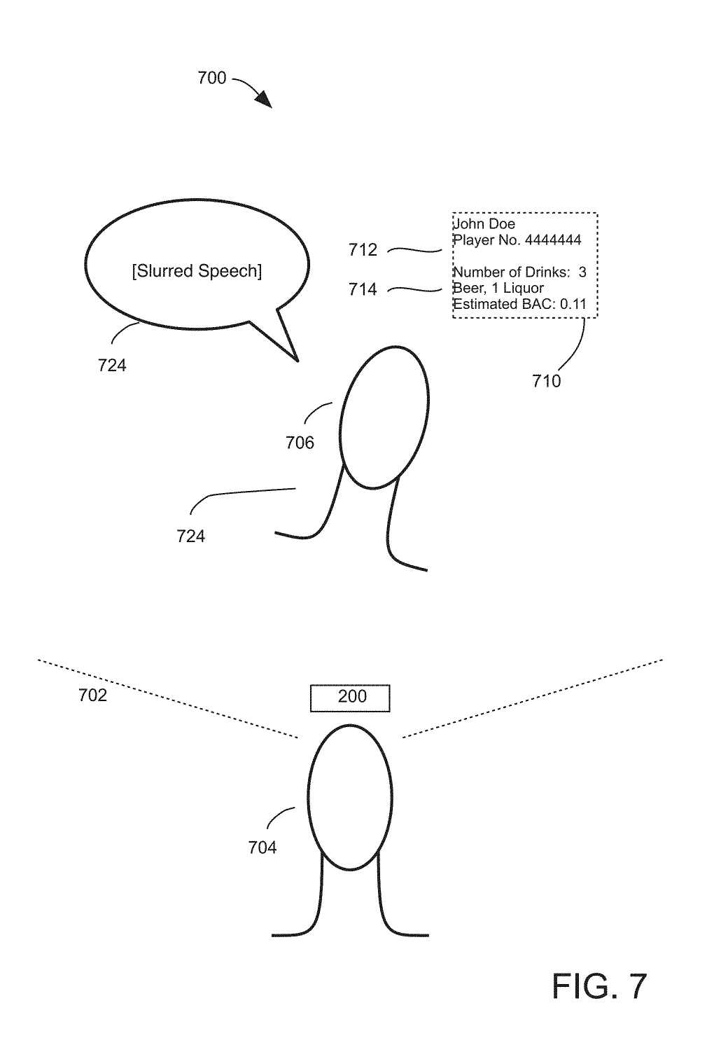

In some embodiments, the AR viewer 200 can aid in making determinations based on non-verbal cues and behaviors of a player. In this regard, FIG. 7 is a view illustrating a user 704 using an AR viewer 200 to determine an intoxication level of a player 706, within a scene 700 associated with a field of view 702 of the user 704, according to an embodiment. In this example, the AR viewer 200 displays one or more indications 710 to the user 704 in real time so that each indication 710 is associated with the player 706 within the scene 700. The indications 710 can include an identity indication 712 that identifies the player 706 and one or more value indications 714, which may include an indication of an intoxication level for the player 706. For example, the AR viewer 200 may determine, based on a live video signal, an estimated blood alcohol content (BAC) level for the player 706. This determination may be calculated based on one or more alcoholic drinks each having a known alcohol content served to the player 706. The determination may also be based on determining a behavior of the player 706 in real time, such as difficulty balancing 724 or slurred speech 726. Other examples of determinations that may be made based on player behavior includes identifying suspicious behavior, such as cheating, recognizing a player's mood, etc. For example, AR viewer may determine an expected action that the dealer of player should take, historical actions and win/losses of the player, either alone or combined with different dealers and/or players. Unusual activity could be highlighted, such as unusual hand, body or eye motions, unusual betting patterns, or unusual win streaks.

It should be understood that different users within the casino operation may have access to different AR applications and functionality. For example, all users may have access to functionality relating to determining a player's mood and cultural preferences, while functionality relating to identifying drink preferences and BAC levels may be provided to cocktail servers and food staff, functionality relating to determining game results and detecting cheating may be provided to dealers and pit bosses, etc. It should also be understood that, as with determining the identity of the player 706, the AR viewer 200 may determine different behaviors (such as mood, impairment, suspicious activity, etc.) directly, e.g., by processing input from the live video signal to determine the behaviors or indirectly, e.g., by receiving a manual or other input from the user 404 or another individual observing the behavior.

In another example, when a user interacts with a customer the mood is determined recorded. The AR viewer or network-connected system can detect a change in mood over time and react. For example, the player's mood might be decreasing or suddenly worsen. The network-connected system could determine that the player prefers interacting with certain employees. If the player has a mood preference for a certain employee the casino management software could assign that employee to interact with the customer for future interactions.

It should also be understood that the embodiments herein may be applied to other aspects of the casino environment, such as monitoring cash drops, casino employee behavior, etc. For example, the AR viewer can note if the correct personnel are in the correct positions and roles on the casino floor, note if the correct people are performing the cash drop, or if the correct waitress is in the assigned area. The embodiments herein may also be used to determine statuses and trends across the casino floor, such as EGM statuses (e.g., error conditions, hold percentages, etc.), popularity of different machines by location, generating a “heat map” of the casino floor to aid the operator in configuring the floor, etc.

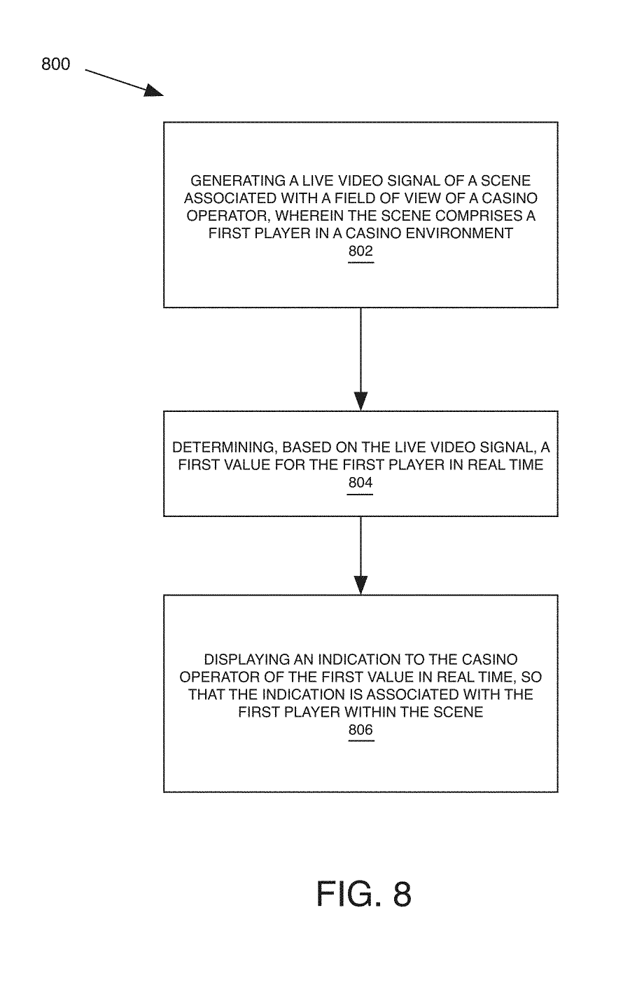

These and other examples may be implemented through one or more computer-implemented methods. In this regard, FIG. 8 is a flowchart diagram of a method 800 of using an AR viewer, such as AR to determine information about a player according to an embodiment. In this embodiment, the method 800 includes generating a live video signal of a scene associated with a field of view of a casino operator, wherein the scene comprises a first player associated with a game in a casino environment (Block 802). The method 800 further includes determining, based on the live video signal, a first value for the first player in real time (Block 804). The method further includes displaying an indication to the casino operator of the identity of the first player and the first value in real time, so that the indication is associated with the first player within the scene (Block 806).

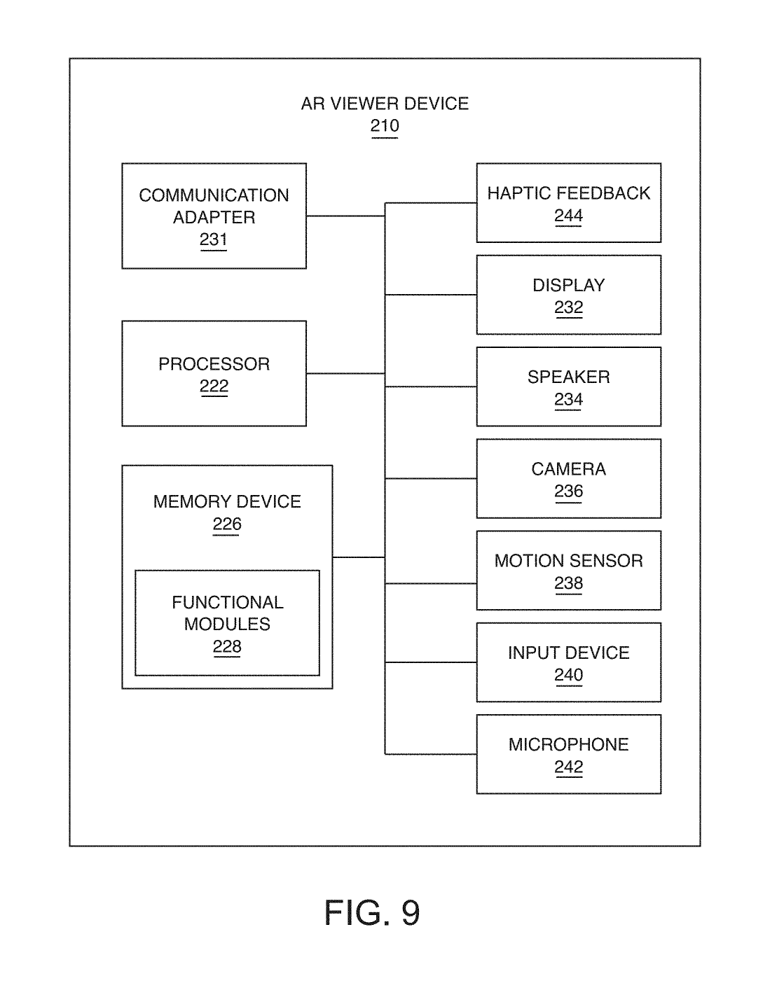

Reference is now made to FIG. 9, which is a block diagram that illustrates various components of an AR viewer device 210, which may embody or include the AR viewer 200, discussed above, according to some embodiments. As shown in FIG. 9, the AR viewer device 210 may include a processor 222 that controls operations of the AR viewer device 210. Although illustrated as a single processor, multiple special purpose and/or general-purpose processors and/or processor cores may be provided in the AR viewer device 210. For example, the AR viewer device 210 may include one or more of a video processor, a signal processor, a sound processor and/or a communication controller that performs one or more control functions within the AR viewer device 210. The processor 222 may be variously referred to as a “controller,” “microcontroller,” “microprocessor” or simply a “computer.” The processor 222 may further include one or more application-specific integrated circuits (ASICs).

Various components of the AR viewer device 210 are illustrated in FIG. 9 as being connected to the processor 222. It will be appreciated that the components may be connected to the processor 222 and/or each other through one or more busses 224 including a system bus, a communication bus and controller, such as a USB controller and USB bus, a network interface, or any other suitable type of connection.

The AR viewer device 210 further includes a memory device 226 that stores one or more functional modules 228 for performing the operations described above. Alternatively, or in addition, some of the operations described above may be performed by other devices connected to the network, such as the network 50 of the system 10 of FIG. 1, for example. The AR viewer device 210 may communicate with other devices connected to the network to facilitate performance of some of these operations. For example, the AR viewer device 210 may communicate and coordinate with certain EGMs to identify players at a particular EGM.

The memory device 226 may store program code and instructions, executable by the processor 222, to control the AR viewer device 210. The memory device 226 may include random access memory (RAM), which can include non-volatile RAM (NVRAM), magnetic RAM (ARAM), ferroelectric RAM (FeRAM) and other forms as commonly understood in the gaming industry. In some embodiments, the memory device 226 may include read only memory (ROM). In some embodiments, the memory device 226 may include flash memory and/or EEPROM (electrically erasable programmable read only memory). Any other suitable magnetic, optical and/or semiconductor memory may operate in conjunction with the gaming device disclosed herein.

The AR viewer device 210 may include a communication adapter 231 that enables the AR viewer device 210 to communicate with remote devices, such as the wireless network, another AR viewer device 210, and/or a wireless access point, over a wired and/or wireless communication network, such as a local area network (LAN), wide area network (WAN), cellular communication network, or other data communication network, e.g., the network 50 of FIG. 1.

The AR viewer device 210 may include one or more internal or external communication ports that enable the processor 222 to communicate with and to operate with internal or external peripheral devices, such as displays 232, speakers 234, cameras 236, sensors, such as motion sensors 238, input devices 240, such as buttons, switches, keyboards, pointer devices, and/or keypads, mass storage devices, microphones 242, haptic feedback devices 244 and wireless communication devices. In some embodiments, internal or external peripheral devices may communicate with the processor through a universal serial bus (USB) hub (not shown) connected to the processor 222. Although illustrated as being integrated with the player device 110, any of the components therein may be external to the AR viewer device 210 and may be communicatively coupled thereto. Although not illustrated, the AR viewer device 210 may further include a rechargeable and/or replaceable power device and/or power connection to a main power supply, such as a building power supply.

In some embodiments, the AR viewer device 210 may include a head mounted device (HMD) and may include optional wearable add-ons that include one or more sensors and/or actuators. Including ones of those discussed herein. The AR viewer device 210 may be a head-mounted augmented-reality (AR) device configured to provide elements of the SVE as part of a real-world scene being viewed by the user wearing the AR viewer device 210.

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product comprising one or more computer readable media having computer readable program code embodied thereon.

Any combination of one or more computer readable media may be used. The computer readable media may be a computer readable signal medium or a non-transitory computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random-access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a non-transitory computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

1. A computer-implemented method comprising:
generating a live video signal of a scene associated with a field of view of a casino operator wearing an augmented-reality (AR) device, wherein the scene comprises a first player in a casino environment;
determining, based on the live video signal, a first value for the first player in real time; and
displaying, by the AR device, an indication to the casino operator of the first value in real time, so that the indication is associated with the first player within the scene.

2. The computer-implemented method of claim 1, further comprising:
determining, based on the live video signal, an identity of the first player; and
displaying, by the AR device, an indication to the casino operator of the identity of the first player within the scene.

3. The computer-implemented method of claim 1, wherein determining, based on the live video signal, the first value for the first player in real time comprises:
determining, based on the live video signal, a wager placed by the first player in real time; and
determining, based at least in part on the wager, an average wager value for the first player, wherein the first value comprises the average wager value.

4. The computer-implemented method of claim 1, wherein the first player is associated with a game in the casino environment, and wherein determining, based on the live video signal, the first value for the first player in real time comprises:
determining, based on the live video signal, a game result for the first player in real time; and
determining, based at least in part on the game result, a win/loss value for the first player, wherein the first value comprises the win/loss value.

5. The computer-implemented method of claim 1, wherein determining, based on the live video signal, the first value for the first player in real time comprises:
determining a drink preference for the first player, wherein the first value comprises the drink preference.

6. The computer-implemented method of claim 1, wherein determining, based on the live video signal, the first value for the first player in real time comprises:
determining a player status for the first player, wherein the first value comprises the player status.

7. The computer-implemented method of claim 1, wherein determining, based on the live video signal, the first value for the first player in real time comprises:
determining a language preference for the first player, wherein the first value comprises the language preference, and
wherein the indication of the first value comprises an indication of the language preference to the casino operator.

8. The computer-implemented method of claim 7, wherein the indication of the first value comprises a phrase based on the language preference.

9. The computer-implemented method of claim 7, wherein determining, based on the live video signal, the first value for the first player in real time further comprises:
determining a first phrase spoken by the first player in a first language corresponding to the language preference of the first player; and
translating the first phrase from the first language to a translated first phrase in a second language, wherein the first value comprises the translated first phrase in the second language, and wherein the indication of the first value comprises in indication of the translated first phrase in the second language.

10. The computer-implemented method of claim 9, wherein determining, based on the live video signal, the first value for the first player in real time further comprises:
determining, based on the first phrase, a responsive phrase to the first phrase, wherein the first value comprises the responsive phrase, and
wherein displaying the indication of the first value in real time comprises displaying the responsive phrase in the first language.

11. The computer-implemented method of claim 1, wherein determining, based on the live video signal, the first value for the first player in real time comprises:
determining a cultural preference for the first player, wherein the first value comprises the cultural preference.

12. The computer-implemented method of claim 1, wherein determining, based on the live video signal, the first value for the first player in real time comprises:
determining a preferred etiquette behavior for the first player, wherein the first value comprises the preferred etiquette behavior, and wherein the indication of the first value comprises in indication of the preferred etiquette behavior.

13. The computer-implemented method of claim 1, wherein determining, based on the live video signal, the first value for the first player in real time comprises:
determining an estimated blood alcohol content (BAC) level for the first player, wherein the first value comprises the BAC level.

14. The computer-implemented method of claim 13, wherein determining the estimated BAC level comprises:
determining an alcoholic drink having a first alcohol content served to the first player; and
determining, based at least in part on the first alcohol content of the alcoholic drink, the estimated BAC level.

15. The computer-implemented method of claim 13, wherein determining the estimated BAC level comprises:
determining a first behavior of the first player in real time; and
determining, based at least in part on the first behavior of the first player, the estimated BAC level.

16. The computer-implemented method of claim 1, wherein the scene comprises a plurality of players comprising the first player, the method further comprising:
determining, based on the live video signal, a second value for a second player of the plurality of players player in real time; and
displaying an indication to the casino operator of the second value in real time, so that the indication is associated with the second player within the scene.

17. The computer-implemented method of claim 1, further comprising:
determining, based on the live video signal, an electronic game machine (EGM) associated with the first player;
determining, based on the live video signal, a second value for the EGM in real time; and
displaying an indication to the casino operator of the second value in real time, so that the indication is associated with the EGM within the scene

18. A system comprising:
a memory; and
a processor circuit coupled to the memory, the processor operable to perform a method comprising:
generating a live video signal of a scene associated with a field of view of a casino operator wearing an augmented-reality (AR) device, wherein the scene comprises a first player in a casino environment;
determining, based on the live video signal, a first value for the first player in real time; and
displaying, by the AR device, an indication to the casino operator of the first value in real time, so that the indication is associated with the first player within the scene.

19. The system of claim 18, wherein the processor is further configured to:
determine, based on the live video signal, an identity of the first player; and
display an indication to the casino operator of the identity of the first player within the scene.

20. (canceled)

21. An augmented-reality (AR) device, comprising:
an image capture device;
a display device;
a processor circuit; and
a memory comprising machine-readable instructions that, when executed by the processor circuit, cause the processor circuit to:
cause the image capture device to generate a live video signal of a scene associated with a field of view of a casino operator wearing the AR device, wherein the scene comprises a first player in a casino environment;
determine, based on the live video signal, a first value for the first player in real time; and
cause the display device to display an indication to the casino operator of the first value in real time, so that the indication is associated with the first player within the scene.
